(19) United States
(12) Patent Application Publication
(10) Pub. No.: US 2024/0182256 A1
(43) Pub. Date: Jun. 6, 2024

(54) PRINT MEDIA DECURLING

(71) Applicant: Hewlett-Packard Development Company, L.P., Spring, TX (US)

(72) Inventors: Isidoro MAYA AGUDO, Sant Cugat del Valles (ES); Francesc GIL I FOSSAS, Sant Cugat del Valles (ES); Eduardo MARTIN ORUE, Sant Cugat del Valles (ES)

(73) Assignee: Hewlett-Packard Development Company, L.P., Spring, TX (US)

(21) Appl. No.: 18/556,433

(22) PCT Filed: Apr. 20, 2021
(86) PCT No.: PCT/US2021/028176

§ 371 Date: Oct. 20, 2023

(51) Int. Cl. B65H 31/02; B65H 31/10

(52) U.S. Cl. CPC B65H 31/02; B65H 31/10; B65H 2301/4212; B65H 2301/51256

(57) ABSTRACT

This disclosure provides printing systems, printing methods, and assemblies for decurling a sheet of print medium. Print media can include paper or other media that can exhibit some tendency to deform when damp or exposed to a certain degree of moisture or moisture. This deformation can be undesirable and can affect the image quality or the perceived image quality of printed matter. To increase the energy efficiency of the procedure for unrolling sheets that have undergone deformation and increase productivity, the following curl unrolling unit is applied, which includes a frame attachable to a sheet collecting tray at an outlet of a printing device, a first corner component mounted on a frame containing a first sloping surface to receive a first corner of a leading edge of a sheet of print medium issued by the printing device, and a second corner component mounted on the frame, comprising a second sloping surface to receive a second corner of a leading edge of the sheet of print medium issued by the printing device.

### BACKGROUND

Printing systems, for example, page-wide array (PWA) scanning head printing systems and, more generally, inkjet printing systems, use printing fluid to print on a print medium. Printing fluids may include latex inks, solvent-based inks, and water-based inks, dry sublimation inks, UV cured inks, aqueous inks, fixers, optimizers.

Print media used in printing systems may comprise a range of materials. Print media may for example comprise paper, which may be provided in a range of grammage options (area density of the print medium, which may be expressed as mass per unit of area). The print medium may be provided as cut sheets or as a continuous roll of print medium.

In double-sided printing systems and methods, print media may be provided in the form of cut sheets. A cut sheet may be provided by a feeder to a printing device for printing on a first side of the cut sheet. The same cut sheet may subsequently be provided, automatically or manually, to a feeder of the printing device for printing of a second side of the cut sheet.

### BRIEF DESCRIPTION

Some non-limiting examples of the present disclosure will be described in the following with reference to the appended drawings, in which:

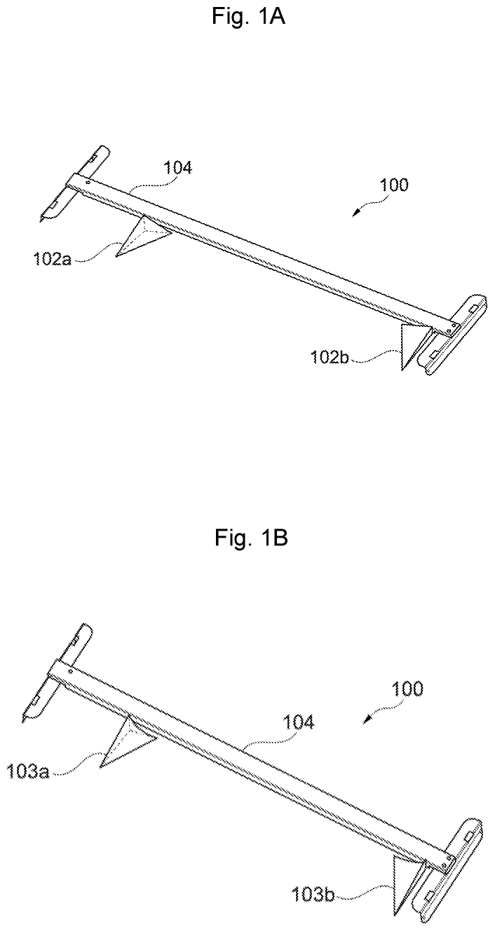

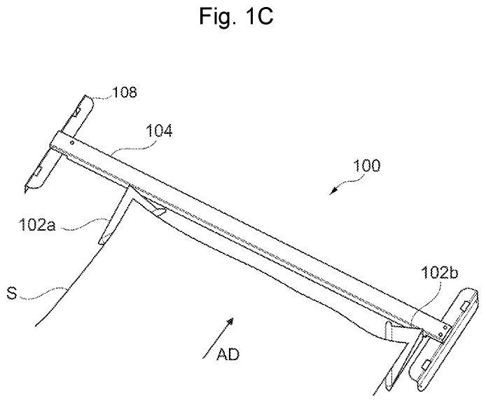

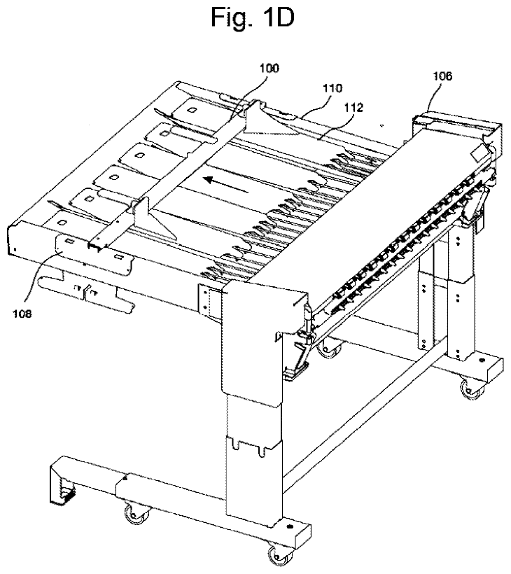

FIGS. 1A-1D are schematic diagrams illustrating decurling assemblies according to examples disclosed herein.

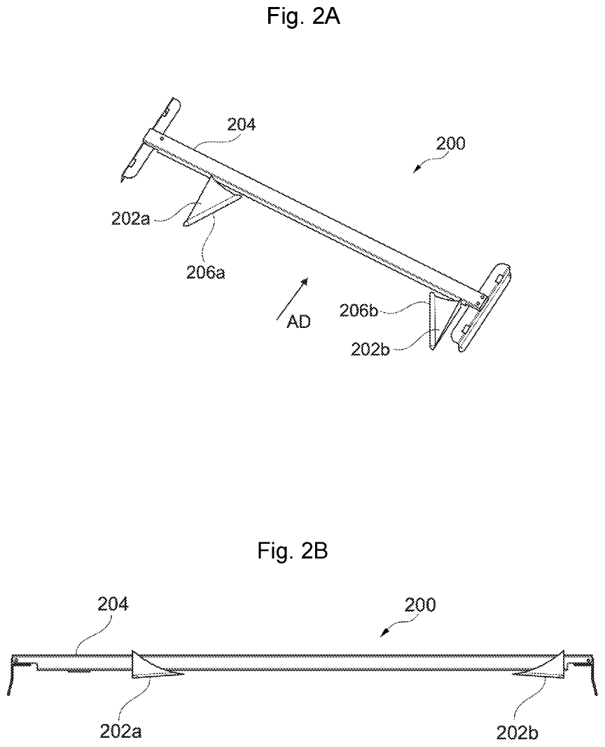

FIGS. 2A-2B are schematic diagrams illustrating decurling assemblies according to examples disclosed herein.

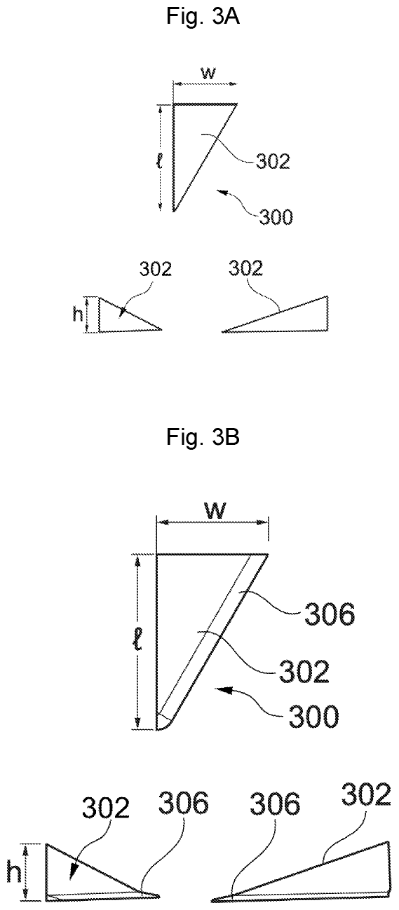

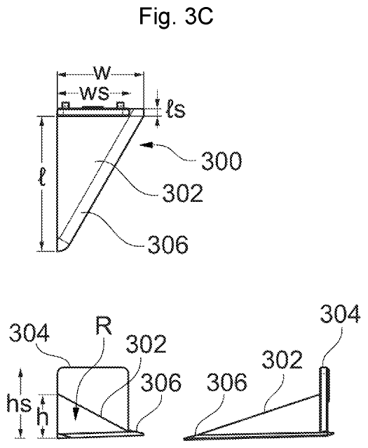

FIGS. 3A-3C are schematic section views illustrating decurling corner components according to examples disclosed herein.

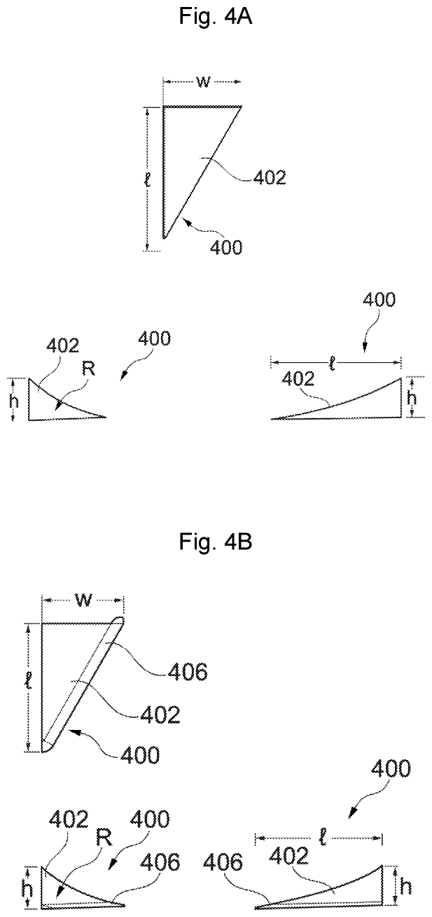

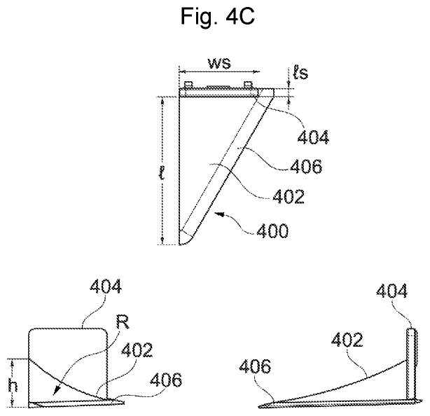

FIGS. 4A-4C are schematic section views illustrating decurling corner components according to examples disclosed herein.

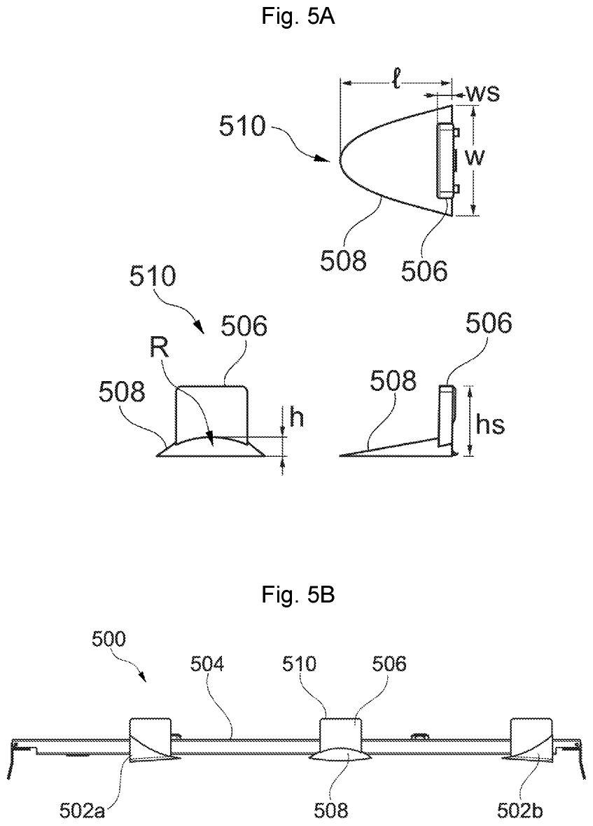

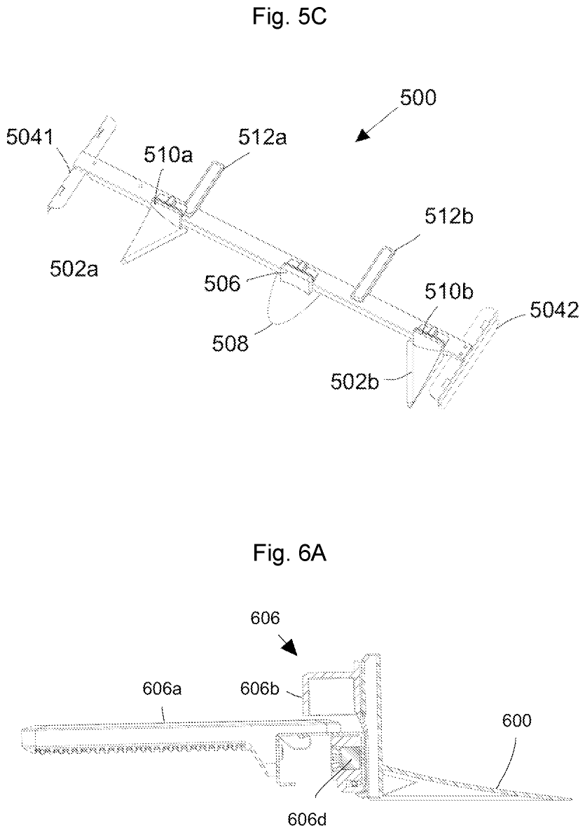

FIGS. 5A-5C are schematic illustrations of a decurling assembly and an intermediate component according to examples.

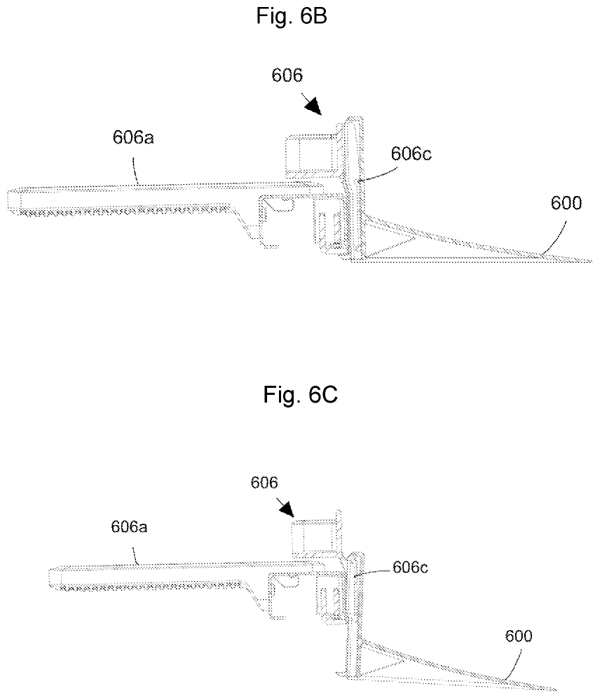

FIGS. 6A-6C are schematic illustrations of a releasable connection component.

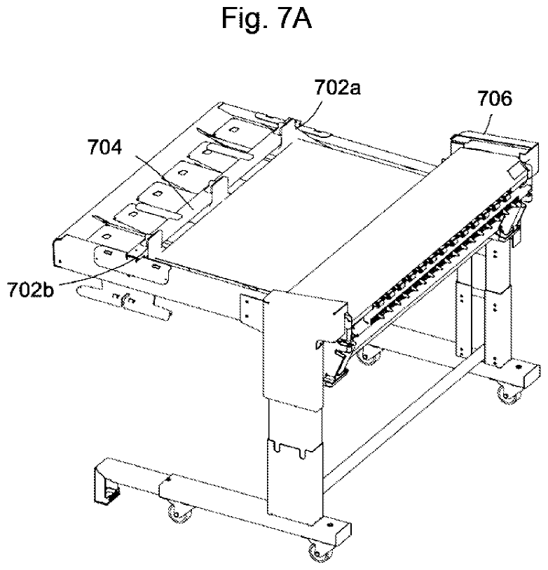

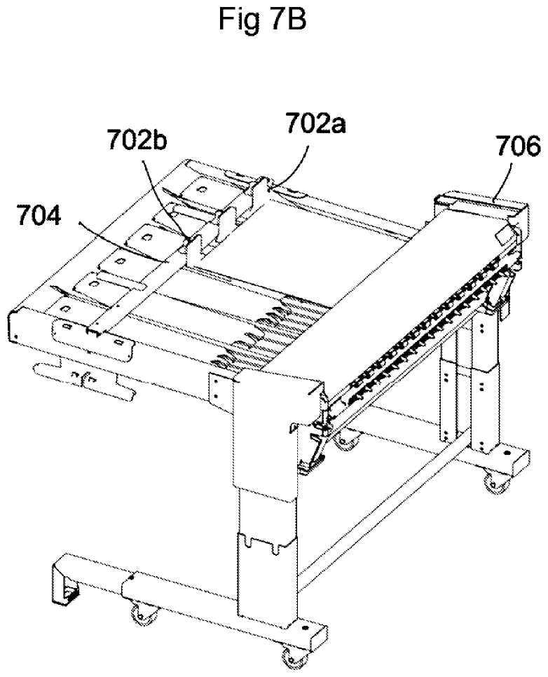

FIGS. 7A-7B a schematic perspective view of a printing device with a decurling assembly according to examples.

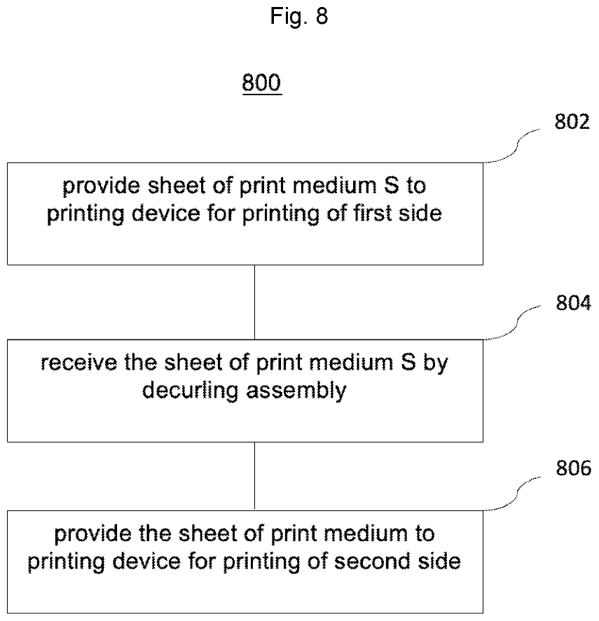

FIG. 8 is a flowchart illustrating methods for printing in accordance with examples disclosed herein.

### DETAILED DESCRIPTION

The present disclosure presents examples of printing systems, printing methods, and assemblies for printing systems and methods. The assemblies may be included, for example, in single-sided and double-sided printing systems and methods.

Inkjet printing systems, for example, page-wide array (PWA) or scanning head printing systems, may use a printing fluid to print an image on a print medium. The printing fluid may comprise inks such as water-based inks, aqueous inks, UV cured inks, or solvent-based inks. Some printing fluids may comprise a liquid component at room temperature (for example, water).

Print media may comprise, for example, paper media or other media which may exhibit a degree of propensity to deformation when humidified or exposed to a certain degree or humidity or moisture. Thus, exposure to and/or absorption of, for example, liquid components in the printing fluid such as solvents or water, may cause temporary or permanent deformation of the print medium or portions thereof. In the case of paper print media, propensity to deformation due to exposure to moisture or humidity may be related to the grammage (that is, the area density of the print medium, which may be expressed as mass per unit of area) of the paper. For example, a paper with greater grammage (that is, a heavier paper), may be less deformable than a paper with lower grammage (lighter paper). Deformability of the paper may also be related to the material composition of the print medium.

Such deformation may be undesirable and may affect the image quality or perceived image quality of the print product.

Such deformation or curling may also cause issues when the sheet of print medium is to be used in double-sided printing. For example, the extent and/or orientation of the deformation of a sheet of print medium after the first side has been printed may be such that the sheet of print medium may collide with a printhead as it is advanced for printing of the second side.

In some printing methods, the print media may be conditioned after printing, for example, by drying and/or ironing the sheet of print medium. In the case of double-sided printing the print medium may be dried or ironed after printing of side A and prior to printing of side B of the sheet of print medium. However, the process of drying and/or ironing may be time-consuming and/or may involve additional equipment (for example, heating implements). Further, the process of drying and/or ironing may also be power-consuming, and this may reduce the energy efficiency of printing systems and methods which include such processes.

A decurling assembly is provided for decurling a sheet of print medium at an outlet of a printing device, the decurling assembly comprising a frame attachable to a sheet collecting tray at an outlet of a printing device, a first corner component mounted on the frame, comprising a first sloping surface to receive a first corner of a leading edge of a sheet of print medium issued by the printing device, and a second corner component mounted on the frame, comprising a second sloping surface to receive a second corner of a leading edge of the sheet of print medium issued by the printing device.

A decurling assembly 100 is shown in FIG. 1A according to examples. The decurling assembly 100 comprises a first corner component 102a, a second corner component 102b, and a frame 104. The frame 104 may comprise, for example, a supporting bar. The supporting bar may support the first corner component 102a and the second corner component 102b. The frame 104 provides a separation distance between the first corner component 102a and the second corner component 102b. An arrow shows an advancing direction AD of a sheet of print medium S as it is ejected at an outlet of a printing device (not shown). In the example, the sheet of print medium S is advanced out of a printing device after a first side (which may be referred to as side A) of the sheet of print medium has been printed on.

The corner components 102a,b comprise a sloping surface of gradually increasing height. The height of the corner components increases gradually along two directions starting at a plane that is parallel to the plane containing the advancing direction AD. In examples, the sloping surface may comprise a triangular cross-section along a plane containing the point of greatest height of the sloping surface. The corner components may cause portions of the sheet of print medium to be raised with respect to a horizontal surface (for example, a stacking surface). In examples, the height of the sloping surfaces of the corner components increases gradually in height in an advancing direction as well as in a direction perpendicular to the advancing direction. Thus, a gradual upward surface may be formed which may receive the sheet(s) of print medium with reduced resistance.

In examples, the slope of the sloping surface is substantially constant between a minimum height of the sloping surface and a maximum height of the sloping surface of the corner component.

A first leading corner and a second leading corner of the sheet of print medium S are identified by the reference labels LC1 and LC2, respectively.

A decurling assembly according to examples herein may be positioned at an outlet of a printing device such that, during printing, as a sheet of print medium is advanced along an advancing the direction AD out of a printing device, the leading corners LC1, LC2 of the sheet of print medium may be received by the gradual sloping surface of the first and second components 102a,b as shown in FIG. 1C.

Upon printing or after printing, a sheet of print medium may exhibit a deformation or may exhibit a tendency to deform or curl. The sloping surface of the decurling assembly corner components may counter or reduce such deformation. The sloping surfaces described herein may be alternatively referred to herein as decurling surfaces.

The decurling assembly 100 may be positioned on, for example, a stacker or other similar apparatus at an outlet of a printing device such that the decurling assembly receives the sheet(s) of print medium as the sheets are ejected from a printing area. For example, the frame 104 may be positioned substantially perpendicular to the print medium advancing direction AD.

In examples, the decurling assembly 100 may be arranged such that it receives the sheet or sheets of printing medium after printing of a first side of the sheet of print medium. Portions of the sheet of print medium may be decurled as they are received by the decurling assembly.

In double-sided printing of print media in the form of cut sheets, a cut sheet of print medium may be provided by a feeder of a printing device or system for printing of a first side. This may be referred to as side A printing. After printing of the first side, the same cut sheet may be provided to the printing device for printing of a second side of the cut sheet of print medium.

The decurling assembly 100 may receive multiple sheets of print medium. The number of sheets of print medium that may be received by the decurling assembly and stacked thereon may be related to the height of the corner components 102a, 102b. A decurling effect of the decurling assembly may decrease as the number of sheets accumulated on the corner components of the decurling assembly increases.

This may be a consideration for dimensioning of the components of the decurling assemblies according to the examples. For example, components having a greater vertical height and a greater horizontal length along the advancing direction AD may be provided for accumulating a greater number of sheets.

In examples, the sloping surface of the corner components may comprise a rectilinear surface.

In examples, the sloping surface of the corner components may comprise a curved profile.

FIG. 1B schematically illustrates a decurling assembly 101 according to examples. The decurling assembly 101 shown in FIG. 1B differs from the decurling assembly shown in FIG. 1A in that each of the corner components 103a,b of the decurling assembly 101 comprise a curved concave sloping surface instead of a rectilinear sloping surface. The structure and operation of the remaining components of the decurling assembly 101 may substantially be the same as hereinbefore described.

A curved concave surface may increase a decurling effect in view of the cavity that is formed between the bottom of the corner component and the top of the corner component. For example, gravity may cause the portions of the sheet of print medium to yield from an original deformed position and bend in a different direction and into the cavity formed by the concave surface of the corner components of the decurling assembly.

In both straight/rectilinear sloping surfaces and curved surface examples, the height may increase gradually along two different directions, namely, a lengthwise direction parallel to the advancing direction AD, and the height direction, which may be substantially perpendicular to the advancing plane (i.e., the plane containing the advancing direction arrow AD).

In examples, the first and second corner components of a decurling assembly may comprise different sloping surfaces and/or different dimensions.

In examples, the decurling assembly 100 may be attached to a stacker via the frame 104. The frame 104 may comprise a supporting bar. The frame 104 may comprise lateral extensions (for example, positioning elements), for positioning and/or attaching the frame 104 to a printing device. For example, the decurling assembly may be attached to or positioned on a stacker of a printing device. FIG. 1D shows example decurling assembly 100 positioned on a printing device 106. The decurling assembly may be positioned such that the supporting bar of the frame 104 is substantially perpendicular to a plane containing the print medium advancing direction AD (shown by the arrow). In examples, the frame of the decurling assembly may comprise positioning elements 108 (as shown in FIG. 1C) to attach and/or position the decurling assembly 100 on a printing device 106 as shown in FIG. 1D. In examples, the positioning elements 108 may each comprise an extension that may extend the length provided by the frame 104. In examples, the positioning elements and their respective extensions may be attached to the frame via a mechanism for longitudinal expansion or contraction of the extensions with respect to the supporting bar so that the frame may be adapted to stackers of different sizes or different widths.

In examples, the frame or positioning elements may comprise a mechanism for providing a biased attachment between the frame and a stacker. For example, the frame or positioning elements may comprise a spring locking mechanism that is biased for contraction of the positioning elements with respect to the supporting bar or frame. In that manner, the frame or positioning elements may grip the stacker. In examples, the frame may comprise a length between 100 and 130 cm. In examples, an extension of each positioning element may comprise a length between 10 and 20 cm.

In examples, the corner components of the decurling assembly may comprise a backstop to stop advancement of the sheet of print medium.

According to examples, a decurling assembly as described in the examples herein may be provided such that it may be retrofitted onto stackers and/or printing devices.

FIG. 1D shows an example decurling assembly provided on a printing device.

FIG. 2A schematically illustrates a perspective view of decurling assembly 200 comprising corner components 202a, b, a frame 204. The decurling assembly 200 differs from the examples described above in that the first and second corner components 202a, comprise extensions 206a,b, respectively. The extensions 206a, b may be monolithically formed with the corner component sloping surfaces and may facilitate entry of a sheet of print medium into the sloping surface of the corner components. The extensions 206a,b may increase stability of the decurling assembly. The extensions 206a,b may be substantially flat and may comprise a uniform height that is lower than or equal to the minimum height of the sloping surface of the corner components. FIG. 2B shows a front view of the example decurling assembly 200.

FIGS. 3A-3D schematically illustrate various examples of corner components 300. In FIG. 3A an example corner component 300 is shown comprising a rectilinear sloping surface with a height (h), a length (l) and a width (w). In examples, the corner component 300 according to the example of FIG. 3A may comprise a height (h) between 25 and 75 mm, a length (l) between 100 and 200 mm, and a width (w) between 75 and 125 mm.

FIG. 3B shows an example corner component 300 comprising a rectilinear sloping surface with a height (h), a length (l) and a width (w). In the example of FIG. 3B, the corner component 300 may comprise an extension 306. In examples, the corner component 300 according to the example of FIG. 3B may comprise a height (h) between 25 and 75 mm, a length (l) between 100 and 200 mm, and a width (w) between 75 and 125 mm.

FIG. 3C shows an example corner component 300 comprising a rectilinear sloping surface with a height (h), a length (l) and a width (w). In examples, the corner component 300 according to the example of FIG. 3A may comprise a height (h) between 25 to 75 mm, a length (l) between 100 to 200 mm, and a width (w) between 75 to 125 mm. In the example of FIG. 3B, the corner component 300 may comprise an extension 306 and a backstop 304. In examples, the backstop 304 may comprise a length (ls) between 5 and 10 mm, and a width (ws) between 50 and 125 mm.

FIGS. 4A-4C shows several examples of a corner component 400 comprising a curved concave surface. The corner components according to the examples 400 comprise a sloping surface with a curved profile. In examples, the curve (arc) of the concave surface of the corner components may correspond to a radius of curvature R (as shown in FIGS. 4A-4C). In examples, the radius of curvature R may be between 100 and 200 mm.

FIG. 4A shows an example corner component 400 comprising a concave curved sloping surface profile. The corner component 400 according to the example of FIG. 4A may comprise a height (h) between 25 and 75 mm, a length (l) between 100 and 200 mm, and a width (w) between 75 and 125 mm.

FIG. 4B shows an example corner component 400 comprising a concave curved sloping surface profile and an extension 406. The corner component 400 according to the example of FIG. 4B may comprise a height (h) between 25 and 75 mm, a length (l) between 100 and 200 mm, and a width (w) between 75 and 125 mm.

FIG. 4C shows an example of a corner component 400 comprising a curved concave sloping surface, an extension 406 and a backstop 404. The corner component 400 according to the example of FIG. 4C may comprise a height (h) between 25 and 75 mm, a length (l) between 100 and 200 mm, and a width (w) between 75 and 125 mm. In examples, the backstop 404 may comprise a length (ls) between 5 and 10 mm, and a width (ws) between 50 and 125 mm.

FIGS. 5A-5B shows a decurling assembly 500 according to examples. The decurling assembly 500 differs from the previously described decurling assembly examples in that it comprises an intermediate component 508. The structure and operation of the remaining components of the decurling assembly 500 may substantially be the same as hereinbefore described. The decurling assembly 500 comprises a frame 504, a first corner component 502a, a second corner component 502b, and an intermediate component 508. The intermediate component 508 may comprise a convex sloping surface to receive a portion of a leading edge of a sheet of print medium.

In examples, the intermediate component 508 may be a removable intermediate component. A removable intermediate component 508 may be removed from the decurling assembly and may be re-attached to the decurling assembly. For example, the intermediate component may be removed or attached depending on the size of print medium to be used in a print job. For example, the intermediate component may be removed or attached to the decurling assembly depending on the width of the print medium. A sheet of print medium may be prone to curling along a central portion of the sheet of print medium depending on its width with respect to the advancing direction AD. In examples, an intermediate component may provide a decurling effect in landscape printing. An intermediate component on the decurling assembly may receive a portion, for example, a central portion, of a leading edge of the sheet of print medium. An intermediate component may also provide a decurling effect in printing modes such as landscape mode. As shown in FIG. 5B, the intermediate component may comprise a curved convex surface corresponding to a radius of curvature R. In examples, the intermediate component may comprise a radius of curvature R between 75 and 125 mm. The intermediate component may comprise a height (h) between 10 and 30 mm, a length (l) between 100 and 150 mm, and a width (w) between 100 and 150 mm.

A stopper 506 may be provided on the frame of the decurling assembly. In examples, the stopper 506 may be provided adjacent to the intermediate component 508 (that is, on an opposite side of the decurling surface of the intermediate component). A stopper 506 may also be provided on a decurling assembly that does not comprise an intermediate component. In examples, the stopper 506 may have a length (l) as shown in FIG. 5B. In examples, the stopper may comprise a length (l) between 10 and 25 mm. In examples, wherein the corner components of a decurling assembly comprise a backstop, the length (l) of the stopper may be greater than the length (l) of the backstop of the corner components.

The stopper 506 may be dimensioned to have a length such that, in use (for example, facing an outlet of a printing device) a sheet of print medium S advancing along direction AD may collide with the stopper 506 and this may stop the advancement of the sheet of print medium beyond the stopper.

In examples, the corner components 502a,b of decurling assembly 500 may comprise a rectilinear sloping surface. In examples, the corner components 502a,b of decurling assembly 500 may comprise a curved concave surface.

FIG. 5C shows an example decurling assembly 500 comprising handles 512a,b. The handles may facilitate positioning of the decurling assembly on, for example, a stacker or a printing device. The decurling assembly 500 according to the example shown in FIG. 5C comprises a frame 504, positioning elements (5041,5042), corner components 502a,b, backstops 510a,b, a stopper 506, and an intermediate component 508.

In examples, a connection between the corner components and the frame may be a displaceable connection.

In examples, the corner components of the decurling assembly may be slidably connected to the frame (or supporting bar of the frame). In examples, the connection of the corner components with respect to the frame or supporting may comprise a releasable connection. A releasable connection between the corner components and the frame may be engaged and disengaged to move (or slide) the corner components along the frame or a portion thereof. In examples, the releasable connection may comprise a magnetic mechanism.

In the example shown in FIGS. 6A-6C show an example corner component 600 connected to frame 604 via a releasable connection component 606. FIG. 6A shows a releasable connection component 606. The releasable connection component 606 may comprise a handle 606a and mechanism elements 606b, 606c and 606d. Mechanism element 606c may comprise a magnetic element to provide a magnetic connection between the corner component and the frame. FIG. 6B shows a first position of the releasable connection component 606. The releasable connection component 606 may be attached to the corner component such that it may be lifted and tilted with respect to the corner component with respect to a vertical axis perpendicular to a longitudinal axis (that is, a lengthwise axis of the frame). The releasable connection component 606 may be controlled (for example, manually via the handle 606a) to release the connection and to engage the connection between the corner component 606 and the frame.

FIG. 6C shows a second position of the releasable connection component 606, wherein the connection between the corner component 600 and frame 604 is disengaged (or partially disengaged) to allow for guiding (for example, sliding) of the corner component with respect to the frame (or a length thereof). Lifting the component 606 may cause the magnetic connection provided by 606d to be released and allow for movement of the corner component 600 along the frame. The release of the connection or attachment between the corner component(s) and the frame may be a partial release, that is, it may be merely sufficient to allow for the displacement of the corner component(s) with respect to the frame.

In examples, the first and second corner components provided on a decurling assembly may be displaceable along a length of the frame of the decurling assembly. In examples, the decurling surface or surfaces provided on a stacker or on a printing device may be displaceable along a length perpendicular to the print medium axis. In that manner, the location or position of the corner components on the frame of a decurling assembly (or decurling surfaces on a stacker or printing device) may be adapted for use with different sizes of print medium or may be adapted to different printing modes (for example, portrait or landscape printing modes). In the example shown in FIGS. 7A-7B, the decurling surfaces or corner components 702a, 702b are provided on a frame 704 first position (e.g., landscape-mode printing) at an outlet of a printing device 706 in FIG. 7A. In FIG. 7B the decurling surfaces or corner components 702a, b on the frame 704 have been displaced to a second position (e.g., a position adapted for portrait-mode printing).

In the examples described herein, the decurling assembly and/or components thereof may comprise a solid material, for example a plastic material (for example, polyamide 12, Acrylonitrile Butadiene Styrene, polyphenylene oxide, or other plastic materials and/or any combination thereof), and/or a metallic material (for example, steel), and/or any derivatives thereof, and/or any combinations thereof. In examples, the decurling assembly may be manufactured via a multi-jet fusion process (MJF). In examples, the decurling assembly may be manufactured via an injection-molding process. In examples, the frame may be monolithically formed with the corner components. In examples, the corner components may be monolithically formed with backstops.

In examples, the frame of a decurling assembly may be integrally formed in the stacker, for example, by injection molding, 3D printing, MJF, or similar manufacturing methods.

In examples, a printing device is provided comprising a decurling surface for decurling a sheet of print medium at an outlet of a printing device, wherein the decurling surface comprises a first surface at a first position on the frame to receive a first leading corner of the sheet of print medium, a second surface at a second position on the frame to receive a second leading corner of the sheet of print medium.

In examples, a printing device is provided comprising a decurling surface for decurling a sheet of print medium at an outlet of a printing device, wherein the decurling surface comprises a first curved surface at a first position on the frame to receive a first leading corner of the sheet of print medium, a second curved surface at a second position on the frame to receive a second leading corner of the sheet of print medium.

In examples, a stacker is provided comprising a decurling assembly, the decurling assembly comprising a frame attachable to a sheet collecting tray at an outlet of a printing device, a first corner component mounted on the frame, comprising a first sloping surface to receive a first corner of a leading edge of a sheet of print medium issued by the printing device, and a second corner component mounted on the frame, comprising a second sloping surface to receive a second corner of a leading edge of the sheet of print medium issued by the printing device. The frame of the decurling assembly may be integrally formed with the stacker, for example, via an injection-molding process, a 3D printing process, or other manufacturing methods.

In examples, a stacker is provided comprising a decurling surface, the decurling surface comprising a first corner component, comprising a first sloping surface to receive a first corner of a leading edge of a sheet of print medium issued by a printing device, and a second corner component, comprising a second sloping surface to receive a second corner of a leading edge of the sheet of print medium issued by a printing device.

In examples, a stacker is provided comprising a decurling surface for decurling a sheet of print medium at an outlet of a printing device, wherein the decurling surface comprises a first curved surface at a first position on the frame to receive a first leading corner of the print medium, a second curved surface at a second position on the frame to receive a second leading corner of the print medium.

FIG. 8 shows a printing method 800 according to examples. In block 802 a sheet of print medium is provided to a printing device for printing on a first side of the sheet of print medium. In block 804 the sheet of print medium may be ejected by the print head and received by the decurling surface. In block 806 the sheet of print medium S may be provided to the printing device for printing on a second side. The block 806 may be performed automatically or manually. The printing method may comprise a double-sided printing method.

Although a number of particular implementations and examples have been disclosed herein, further variants and modifications of the disclosed devices and methods are possible. For example, not all the features disclosed herein are included in all the implementations, and implementations comprising other combinations of the features described are also possible.

1. A decurling assembly for decurling a sheet of print medium at an outlet of a printing device, the decurling assembly comprising
a frame attachable to a sheet collecting tray at an outlet of a printing device,
a first corner component mounted on the frame, comprising a first sloping surface to receive a first corner of a leading edge of a sheet of print medium issued by the printing device,
and
a second corner component mounted on the frame, comprising a second sloping surface to receive a second corner of a leading edge of the sheet of print medium issued by the printing device.

2. The decurling assembly of claim 1, wherein the first and second sloping surfaces comprise a rectilinear sloping surface or a curved sloping surface.

3. The decurling assembly of claim 1, wherein the first and second sloping surfaces comprise a concave sloping surface.

4. The decurling assembly of claim 1, wherein the first and second sloping surfaces comprise a curved concave sloping surface.

5. The decurling assembly of claim 1, comprising an intermediate component between the first corner component and the second corner component, the intermediate component comprising a sloping surface to receive a portion of a leading edge of the sheet of print medium between the first leading corner and the second leading corner.

6. The decurling assembly of claim 1, comprising a stopper between the first corner component and the second corner component to stop advancement of a sheet of print medium.

7. The decurling assembly of claim 1, wherein the first corner component and the second corner component are displaceable along a length of the frame.

8. The decurling assembly of claim 5, wherein the intermediate component sloping surface comprises a convex sloping surface.

9. The decurling assembly of claim 1, wherein the first corner component and the second corner component comprise a backstop to stop advancement of a sheet of print medium.

10. The decurling assembly of claim 1, wherein the first corner component and the second corner component are slidably connected to the frame.

11. The decurling assembly of claim 10, wherein the first corner component and the second corner component are connected to the frame via a releasable connection mechanism.

12. A printing device, comprising a decurling surface for decurling a sheet of print medium at an outlet of a printing device,
wherein the decurling surface comprises
a first curved surface at a first position on the frame to receive a first leading corner of the sheet of print medium,
a second curved surface at a second position on the frame to receive a second leading corner of the sheet of print medium.

13. The printing device of claim 12, comprising an intermediate curved surface at an intermediate position on the frame between the first curved surface and the second curved surface.

14. A method for printing a sheet of print medium on a printing device, comprising:
feeding the sheet of print medium to a print engine and outputting the sheet of print medium through an outlet,
providing a stacking surface at an outlet of a printing device to receive portions of a leading edge of the sheet of print medium,
wherein the stacking surface comprises a plurality of sloping components to receive portions of a leading edge of a sheet of print medium.

15. The method of claim 14, comprising, after the sheet of print medium has been received by the decurling surface, providing the sheet of print medium to the printing device for painting on a second side of the sheet of print medium.
